(19) United States
(12) Patent Application Publication
(10) Pub. No.: US 2026/0152668 A1
(43) Pub. Date: Jun. 4, 2026

(54) TOUGHENED, LOW ODOR/LOW BLOOM CYANOACRYLATE COMPOSITIONS

(71) Applicant: Henkel AG& Co. KGaA, Duesseldorf (DE)

(72) Inventors: Isidro Cobo, Dublin (IE); Marisa Phelan, Dublin (IE); Viktorija Sadauskaite, Dublin (IE); Emer Ward, Dublin (IE); Raymond Tully, Dublin (IE); Barry N. Burns, Dublin (IE); Rory Barnes, Dublin (IE); Rachel Hersee, Dublin (IE)

(21) Appl. No.: 19/327,375

(22) Filed: Sep. 12, 2025

Related U.S. Application Data
(63) Continuation of application No. 16/858,655, filed on Apr. 26, 2020.
(63) Continuation of application No. PCT/EP2018/079485, filed on Oct. 26, 2018.

(30) Foreign Application Priority Data
Oct. 27, 2017 (GB) 1717707.2

(51) Int. Cl. C09J 4/06; C08F 222/32; C08K 5/092; C08K 5/11; C08K 5/12; C08K 5/159; C08L 13/00; C08L 15/02; C09J 11/06; C09J 11/08; C09J 133/14

(52) U.S. Cl. CPC C09J 4/06; C08F 222/327; C08L 13/00; C08L 15/02; C09J 11/06; C09J 11/08; C09J 133/14; C08F 222/325; C08K 5/092; C08K 5/11; C08K 5/12; C08K 5/159

(57) ABSTRACT

This invention relates to cyanoacrylate-containing compositions that include (a) a beta-alkoxy cyanoacrylate component, (b) a cyanoacrylate component selected from the group consisting of 2-methylbutyl cyanoacrylate, isoamyl cyanoacrylate, 2-ethylhexyl cyanoacrylate, 2-pentyl cyanoacrylate, 3-methylpentyl cyanoacrylate, 2-ethylbutyl cyanoacrylate, 3, 7-dimethyloctyl cyanoacrylate, and combinations thereof; and (c) a rubber toughening component. Cured products of the inventive cyanoacrylate compositions demonstrate improved toughness without an odor typically found with cyanoacrylate-containing compositions.

### BACKGROUND

### Field

This invention relates to cyanoacrylate-containing compositions that include (a) a β-alkoxyalkyl cyanoacrylate component, (b) a cyanoacrylate component selected from 2-methylbutyl cyanoacrylate, isoamyl cyanoacrylate, 2-ethylhexyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof; and (c) a rubber toughening component. Cured products of the inventive cyanoacrylate compositions demonstrate improved toughness without an odor typically found with cyanoacrylate-containing compositions or blooming sometimes seen in cured products thereof.

### BRIEF DESCRIPTION OF RELATED TECHNOLOGY

Cyanoacrylate adhesive compositions are well known, and widely used as quick setting, instant adhesives with a wide variety of uses. See H. V. Coover, D. W. Dreifus and J. T. O'Connor, “Cyanoacrylate Adhesives” in Handbook of Adhesives, 27, 463-77, I. Skeist, ed., Van Nostrand Reinhold, New York, 3rd ed. (1990). See also G. H. Millet, “Cyanoacrylate Adhesives” in Structural Adhesives: Chemistry and Technology, S. R. Hartshorn, ed., Plenun Press, New York, p. 249-307 (1986).

U.S. Pat. No. 4,440,910 (O'Connor) pioneered rubber toughened cyanoacrylate compositions through the use of certain organic polymers as toughening additives that are elastomeric, i.e., rubbery, in nature. The '910 patent is thus directed to and claims a curable adhesive comprising a substantially solvent-free mixture of: (a) a cyanoacrylate ester, and (b) about 0.5% to about 20% by weight of an elastomeric polymer. The elastomeric polymer is selected from elastomeric copolymers of a lower alkene monomer and (i) acrylic acid esters, (ii) methacrylic acid esters or (iii) vinyl acetate. More specifically, the '910 patent notes that as toughening additives for cyanoacrylates, acrylic rubbers; polyester urethanes; ethylene-vinyl acetates; fluorinated rubbers; isoprene-acrylonitrile polymers; chlorosulfinated polyethylenes; and homopolymers of polyvinyl acetate were found to be particularly useful.

The elastomeric polymers are described in the '910 patent as either homopolymers of alkyl esters of acrylic acid; copolymers of another polymerizable monomer, such as lower alkenes, with an alkyl or alkoxy ester of acrylic acid; and copolymers of alkyl or alkoxy esters of acrylic acid. Other unsaturated monomers which may be copolymerized with the alkyl and alkoxy esters of acrylic include dienes, reactive halogen-containing unsaturated compounds and other acrylic monomers such as acrylamides.

Conventional commercial ethyl cyanoacrylate compositions have an odor, which some end users find offensive. β-methoxy ethyl cyanoacrylate is known to not have the same odor. Ethyl cyanoacrylate compositions are also known to show blooming when cured, which tends to be absent with β-methoxy ethyl cyanoacrylate.

Today there are no toughened, low odor/low bloom cyanoacrylate products commercially available in the market. Commercially available toughened cyanoacrylate products are predominately based on ethyl cyanoacrylate monomer and exhibit (1) an odor that some end users find offensive and/or (2) sometimes blooming when cured.

Commercially available cyanoacrylate products are often toughened with an ethylene: methyl methacrylate terpolymer. This polymer contributes little toughness to cyanoacrylate compositions containing β-methoxy ethyl cyanoacrylate, one reason for which may be that the polymer shows sparing solubility in β-methoxy ethyl cyanoacrylate.

Notwithstanding the state of the art and the efforts to date to improve the toughness of β-alkoxyalkyl cyanoacrylate compositions, there remained a long felt, yet unmet, need to provide toughness to cured reaction products of such cyanoacrylate compositions, and while doing so minimize the odor and/or blooming oftentimes associated with cyanoacrylate compositions. Until now.

### SUMMARY

Cyanoacrylate compositions comprising (a) a β-alkoxyalkyl cyanoacrylate component, (b) a cyanoacrylate component selected from 2-methylbutyl cyanoacrylate, isoamyl cyanoacrylate, 2-ethylhexyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof; and (c) a rubber toughening component, are thus provided.

The inclusion of the β-alkoxyalkyl cyanoacrylate component provides a cyanoacrylate base for the composition that does not emit an odor commonly found in cyanoacrylate compositions. The cyanoacrylate component recited above provides a vehicle by which to introduce a rubber toughening component to the β-alkoxyalkyl cyanoacrylate component. The rubber toughening component provides for improved toughness, as is shown in the Examples. Rubber toughening components are sometimes known to show sparing solubility in cyanoacrylate compositions, particularly cyanoacrylate compositions containing beta-alkoxyalkyl cyanoacrylates. As a result, the toughness observed in prior attempts has been limited at best. The cyanoacrylate component recited above aids in that regard.

This invention is also directed to a method of bonding together two substrates, which method includes applying to at least one of the substrates a composition as described above, and thereafter mating together the substrates.

In addition, the present invention is directed to reaction products of the inventive compositions.

Also, the invention is directed to a method of preparing the inventive compositions, and a method of conferring improved toughness to a cured reaction product of a cyanoacrylate composition, while minimizing the odor oftentimes associated with cyanoacrylate compositions as well as bloom sometimes observed with cured product thereof.

And the invention is directed to a composition comprising a cyanoacrylate component selected from 2-methylbutyl cyanoacrylate, isoamyl cyanoacrylate, 2-ethylhexyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof; and a rubber toughening component.

The invention will be more fully understood by a reading of the section entitled “Detailed Description”, which follows.

### BRIEF DESCRIPTION OF THE FIGURES

FIG. 1 depicts a bar chart of T-Peel strength on aluminum substrates bonded with Sample A and LOCTITE 435 after curing for a period of time of 3 days, 1 week and 4 weeks at room temperature.

FIG. 2 depicts a bar chart of T-Peel strength on mild steel substrates bonded with Sample A and LOCTITE 435 after curing for a period of time of 3 days, 1 week and 4 weeks at room temperature.

FIG. 3 depicts a bar chart of side impact strength on aluminum substrates bonded with Sample A and LOCTITE 435 after curing for a period of time of 1 week and 4 weeks at room temperature.

FIG. 4 depicts a bar chart of side impact strength on mild steel substrates bonded with Sample A and LOCTITE 435 after curing for a period of time of 1 week and 4 weeks at room temperature.

FIG. 5 depicts a bar chart of T-Peel strength on aluminum substrates bonded with Sample B and LOCTITE FlexGel after curing for a period of time of 3 days and 1 week at room temperature.

FIG. 6 depicts a bar chart of T-Peel strength on mild steel substrates bonded with Sample B and LOCTITE FlexGel after curing for a period of time of 3 days and 1 week at room temperature.

FIG. 7 depicts a bar chart of T-Peel strength on aluminum substrates bonded with Sample C and LOCTITE 435 after curing for a period of time of 3 days and 1 week at room temperature.

FIG. 8 depicts a bar chart of T-Peel strength on mild steel substrates bonded with Sample C and LOCTITE 435 after curing for a period of time of 3 days and 1 week at room temperature.

FIG. 9 depicts a bar chart of T-Peel strength on aluminum substrates bonded with Sample D and LOCTITE FlexGel after curing for a period of time of 3 days and 1 week at room temperature.

FIG. 10 depicts a bar chart of T-Peel strength on mild steel substrates bonded with Sample D and LOCTITE FlexGel after curing for a period of time of 3 days and 7 days at room temperature.

FIG. 11 depicts a bar chart of T-Peel strength on mild steel substrates bonded with Samples E, F and G, with and without a gap of 55 μm.

### DETAILED DESCRIPTION

As noted above, this invention is directed to a cyanoacrylate composition comprising (a) a β-alkoxyalkyl cyanoacrylate component, (b) a cyanoacrylate component selected from 2-methylbutyl cyanoacrylate, isoamyl cyanoacrylate, 2-ethylhexyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof; and (c) a rubber toughening component.

The β-alkoxyalkyl cyanoacrylate component (a) may be chosen from β-methoxymethyl cyanoacrylate, β-methoxyethyl cyanoacrylate, β-ethoxymethyl cyanoacrylate, β-ethoxyethyl cyanoacrylate and combinations thereof. Particularly desirable among those β-alkoxyalkyl cyanoacrylates is β-methoxyethyl cyanoacrylate.

The β-alkoxyalkyl cyanoacrylate component (a) should be included in the compositions in an amount within the range of from about 40% to about 90% by weight, with the range of about 55% to about 75% by weight being desirable, such as from about 55% to about 70% by weight, or from about 55% to about 65% by weight and about 60% by weight of the total composition being particularly desirable.

The cyanoacrylate component (b) may be selected from 2-methylbutyl cyanoacrylate, isoamyl cyanoacrylate, 2-ethylhexyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof.

Suitably, the cyanoacrylate component (b) may be selected from 2-methylbutyl cyanoacrylate, isoamyl cyanoacrylate, 2-ethylhexyl cyanoacrylate, 3-methylpentyl cyanoacrylate, 2-ethylbutyl cyanoacrylate, 3,7-dimethyloctyl cyanoacrylate, and combinations thereof; particularly desirable among those cyanoacrylate components is isoamyl cyanoacrylate.

The cyanoacrylate component (b) should be included in the compositions in an amount within the range of from about 10% to about 50% by weight, with the range of about 20% to about 35% by weight being desirable, and about 30% by weight of the total composition being particularly desirable.

The rubber toughening component (c) may be selected from (i) reaction products of the combination of ethylene, methyl acrylate and monomers having carboxylic acid cure sites, (ii) dipolymers of ethylene and methyl acrylate, (iii) vinylidene chloride-acrylonitrile copolymers, (iv) vinyl chloride/vinyl acetate copolymer, (v) copolymers of polyethylene and polyvinyl acetate, and combinations thereof.

Desirably, the reaction products (c) (i) of the combination of ethylene, methyl acrylate and monomers having carboxylic acid cure sites, where the reaction products are substantially free of release agents, anti-oxidants, stearic acid and polyethylene glycol ether wax, β-alkoxyalkyl cyanoacrylate are chosen for use. DuPont supplies such a reaction product under the trade name VAMAC VCS 5500.

The rubber toughening component (c) should be included in the compositions in an amount within the range of from about 3% to about 20% by weight, with the range of about 5% to about 15% by weight being desirable, and about 8% by weight of the total composition being particularly desirable.

Thus, desirably the inventive composition in a preferred embodiment includes the following components in the by weight percent ranges noted in Table 1 below.

TABLE 1

| Constituent | Broad range | Desirable range |
|---|---|---|
| β - Methoxy Ethyl Cyanoacrylate | 40-90% | 55-75% |
| Isoamyl Cyanoacrylate | 10-50% | 20-35% |
| VAMAC VCS 5500 | 3-20% | 5-15% |

Accelerators may also be included in the inventive cyanoacrylate compositions, such as any one or more selected from calixarenes and oxacalixarenes, silacrowns, crown ethers, cyclodextrins, poly(ethyleneglycol) di(meth)acrylates, ethoxylated hydric compounds and combinations thereof.

Of the calixarenes and oxacalixarenes, many are known, and are reported in the patent literature. See e.g. U.S. Pat. Nos. 4,556,700, 4,622,414, 4, 636, 539, 4, 695, 615, 4, 718, 966, and 4,855, 461, the disclosures of each of which are hereby expressly incorporated herein by reference.

For instance, as regards calixarenes, those within the following structure are useful herein:

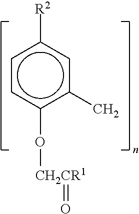

where R¹ is alkyl, alkoxy, substituted alkyl or substituted alkoxy; R² is H or alkyl; and n is 4, 6 or 8.

One particularly desirable calixarene is tetrabutyl tetra[2-ethoxy-2-oxoethoxy]calix-4-arene.

A host of crown ethers are known. For instance, any one or more of 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5,3,4,5-naphtyl-16-crown-5, 1,2-methyl-benzo-18-crown-6, 1,2-methylbenzo-5, 6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7 may be used. See U.S. Pat. No. 4,837,260 (Sato), the disclosure of which is hereby expressly incorporated herein by reference. Of the silacrowns, again many are known, and are reported in the literature.

Specific examples of silacrown compounds useful in the inventive compositions include:

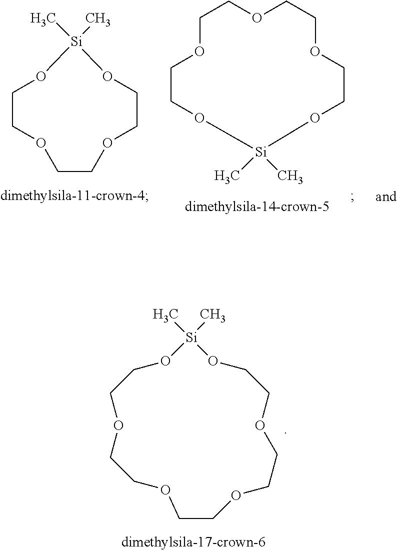

See e.g. U.S. Pat. No. 4,906,317 (Liu), the disclosure of which is hereby expressly incorporated herein by reference.

Many cyclodextrins may be used in connection with the present invention. For instance, those described and claimed in U.S. Pat. No. 5,312,864 (Wenz), the disclosure of which is hereby expressly incorporated herein by reference, as hydroxyl group derivatives of an α, β or γ-cyclodextrin which is at least partly soluble in the cyanoacrylate would be appropriate choices for use herein as the first accelerator component.

For instance, poly(ethylene glycol) di(meth)acrylates suitable for use herein include those within the following structure:

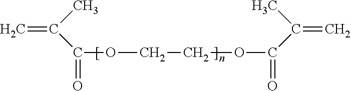

where n is greater than 3, such as within the range of 3 to 12, with n being 9 as particularly desirable. More specific examples include PEG 200 DMA, (where n is about 4) PEG 400 DMA (where n is about 9), PEG 600 DMA (where n is about 14), and PEG 800 DMA (where n is about 19), where the number (e.g., 400) represents the average molecular weight of the glycol portion of the molecule, excluding the two methacrylate groups, expressed as grams/mole (i.e., 400 g/mol). A particularly desirable PEG DMA is PEG 400 DMA.

And of the ethoxylated hydric compounds (or ethoxylated fatty alcohols that may be employed), appropriate ones may be chosen from those within the following structure:

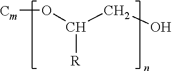

where Cₘ can be a linear or branched alkyl or alkenyl chain, m is an integer between 1 to 30, such as from 5 to 20, n is an integer between 2 to 30, such as from 5 to 15, and R may be H or alkyl, such as C₁₋₆ alkyl.

When used, the accelerator should be included in the compositions in an amount within the range of from about 0.01% to about 10% by weight, with the range of about 0.1 to about 0.5% by weight being desirable, and about 0.4% by weight of the total composition being particularly desirable.

A stabilizer package is also ordinarily found in cyanoacrylate compositions. The stabilizer package may include one or more free radical stabilizers and anionic stabilizers, each of the identity and amount of which are well known to those of ordinary skill in the art. See e.g. U.S. Pat. Nos. 5,530,037 and 6,607,632, the disclosures of each of which are hereby incorporated herein by reference.

Other additives may be included in the inventive cyanoacrylate compositions, such as certain acidic materials (like citric acid), thixotropy or gelling agents, thickeners, dyes, and combinations thereof.

Of the accelerators and these additives, those listed in the table below are desirable examples, particularly in the amounts noted.

TABLE 2

| Constituent | Broad range | Desirable range |
|---|---|---|
| Crown Ether | 0.1-0.5% | 0.1-0.2% |
| Citric Acid | 50-100 ppm | 100 ppm |
| Silica | 0-10% | 5-6% |

In addition, the cyanoacrylate component may include further cyanoacrylate monomers which may be chosen with a raft of substituents, such as those represented by H₂C═C(CN)—COOR, where R is selected from C₁₋₁₅ alkyl, alkoxyalkyl, cycloalkyl, alkenyl, aralkyl, aryl, allyl and haloalkyl groups. Desirably, the cyanoacrylate monomer is selected from methyl cyanoacrylate, ethyl-2-cyanoacrylate, propyl cyanoacrylates, butyl cyanoacrylates (such as n-butyl-2-cyanoacrylate), octyl cyanoacrylates, allyl cyanoacrylate, and combinations thereof.

In another aspect of the invention, there is provided a method of bonding together two substrates, which method includes applying to at least one of the substrates a composition as described above, and thereafter mating together the substrates for a time sufficient to permit the adhesive to fixture.

In yet another aspect of the invention, there is provided reaction products of the so-described compositions.

In still another aspect of the invention, there is provided a method of preparing the so-described compositions. The method includes providing (a) a β-akloxyalkyl cyanoacrylate component, and combining therewith with mixing (b) a cyanoacrylate component selected from 2-methylbutyl cyanoacrylate, isoamyl cyanoacrylate, 2-ethylhexyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof; and (c) a rubber toughening component, where desirably the rubber toughening component is dissolved in the cyanoacrylate component in an amount of up to about 20% by weight.

In still yet another aspect of the invention, there is provided a composition comprising a cyanoacrylate component selected from 2-methylbutyl cyanoacrylate, isoamyl cyanoacrylate, 2-ethylhexyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof; and a rubber toughening component, where desirably the rubber toughening component is dissolved in the cyanoacrylate component in an amount of up to about 20% by weight.

The invention will be further illustrated by the examples which follow.

### EXAMPLES

Isoamyl cyanoacrylate and 2-methyl butyl cyanoacrylate unexpectedly solubilized traditional cyanoacrylate tougheners, namely VAMAC. The VAMAC rubber toughener was determined to be soluble in each of the monomers at an amount of up to about 20% by weight.

Due to this observation, VAMAC rubber toughener was added to approximately 30:70 blends of isoamyl cyanoacrylate containing β-methoxy ethyl cyanoacrylate and 2-methylbutyl cyanoacrylate containing β-methoxy ethyl cyanoacrylate in an amount of 8% by weight to form a solution of the inventive cyanoacrylate compositions.

When isoamyl cyanoacrylate or 2-methyl butyl cyanoacrylate is used to solubilize the rubber toughener (here, VAMAC) and then it is introduced as a solution to β-methoxyethyl cyanoacrylate, toughness is observed. And when comparable compositions are prepared in a gel format, an increase in toughness is maintained. To illustrate the results comparisons were carried out with a rubber toughened ethyl cyanoacrylate product and a rubber toughened gel ethyl cyanoacrylate product.

All samples were prepared by mixing together the noted constituents for a sufficient period of time to ensure substantial homogeneity of the constituents. Ordinarily, about 30 minutes should suffice, depending of course on the identity and quantity of the constituents used.

Initially, a rubber toughening component (VAMAC VCS 5500, available from DuPont) was evaluated in β-methoxy ethyl cyanoacrylate and a cyanoacrylate component selected from isoamyl cyanoacrylate or 2-methylbutyl cyanoacrylate.

More specifically, 27.3% by weight isoamyl cyanoacrylate was blended with 63.7% by weight β-methoxy ethyl cyanoacrylates. BF₃ [BF₃OEt₂] 0.9% by weight was added followed by 8% by weight VAMAC VCS 5500. The mixture was heated to a temperature of 65° C. and mixed for approximately 3-4 hours, until all of the VAMAC VCS 5500 was observed to have dissolved. Upon cooling, about 0.1% by weight dibenzo-18-crown-6 ether and about 0.001% by weight of citric acid were added to form Sample A. Sample B was formed by the further addition of 6% by weight of silica.

TABLE 3

| | Sample/Amt (wt %) | |
|---|---|---|
| Components | A | B |
| Isoamyl cyanoacrylate | 27.3 | 24.3 |
| β-Methoxy ethyl cyanoacrylate | 63.7 | 60.7 |
| VCS 5500 | 8 | 8 |
| BF₃ as [BF₃OEt₂] | 0.9 | 0.9 |
| Crown Ether | 0.1 | 0.1 |
| Citric Acid | 0.001 | 0.001 |
| Silica | — | 6 |

Thus, Sample A in Table 3 has no silica, while Sample B has silica, thereby rendering it in gel form.

Separately, 27.3% by weight 2-methylbutyl cyanoacrylate was blended with 63.7% by weight β-methoxy ethyl cyanoacrylates. BF₃ [BF₃OEt₂] in an amount of 0.9% by weight was added followed by 8% by weight VAMAC VCS 5500. The mixture was heated to a temperature of 65° C. and mixed for about 3-4 hours, until all of the VAMAC VCS 5500 was observed to have dissolved. Upon cooling, about 0.1% by weight of dibenzo-18-crown-6 ether and about 0.001% by weight of citric acid were added to form Sample C. Sample D was formed by the further addition of 6% by weight of silica.

TABLE 4

| | Sample/Amt (wt %) | |
|---|---|---|
| Components | C | D |
| 2-Methyl Butyl cyanoacrylate | 27.3 | 24.3 |
| β-Methoxy cyanoacrylate | 63.7 | 60.7 |
| VCS 5500 | 8 | 8 |
| BF₃ as [BF₃OEt₂] | 0.9 | 0.9 |
| Crown Ether | 0.1 | 0.1 |
| Citric Acid | 0.001 | 0.001 |
| Silica | — | 6 |

Thus, Sample C in Table 4 has no silica, while Sample D has silica, thereby rendering it in gel form.

By way of the background, toughness was measured by 180° T Peel testing on mild steel and aluminum substrates (each of which being about 1 inch wide and being aligned with a 90° tab at the end of the assembly to facilitate the peeling, in accordance with ASTM 710/ISO 11339).

For the performance evaluation, the control for Samples A and C was LOCTITE 435, which is a clear rubber toughened ethyl cyanoacrylate product containing 8% by weight VAMAC and for Samples B and D, the control was LOCTITE FlexGel, which is ethyl cyanoacrylate containing VAMAC, PMMA and silica.

Table 5 shows the data captured for the T-Peel strength performance for Samples A and B, as reflected in FIGS. 1, 2, 5 and 6, respectively.

TABLE 5

| | Sample/T-Peel (N/mm) | | | |
|---|---|---|---|---|
| | | | LOCTITE | LOCTITE |
| Time (weeks)/Substrate | A | B | 435 | FlexGel |
| 3 days/Al | 0.57 | 1.31 | 0.64 | 1.93 |
| 1/Al | 0.48 | 2.12 | 0.47 | 2.13 |
| 4/Al | 0.64 | — | 0.29 | — |
| 3 days/MS | 2.28 | 5.55 | 1.53 | 0.75 |
| 1/MS | 2.51 | 5.94 | 1.28 | 0.50 |
| 4/MS | 1.92 | — | 1.33 | 1.33 |

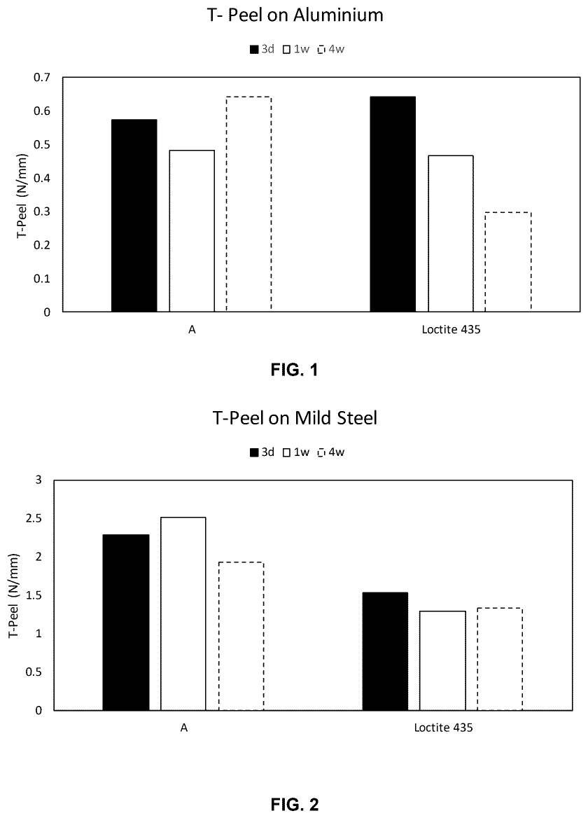

The results depicted in FIGS. 1 and 2 show comparable T-Peel strength performance for Sample A and LOCTITE 435 on aluminum substrates. However, on mild steel substrates Sample A shows improved toughness in terms of T Peel strength performance over LOCTITE 435.

TABLE 6

| | Sample/Side Impact (J) | |
|---|---|---|
| Time (weeks)/Substrate | A | LOCTITE 454 |
| 1/Al | 8.33 | 5.93 |
| 4/Al | 7.16 | 4.83 |
| 1/MS | >13.56 | >13.56 |
| 4/MS | >13.56 | >13.56 |

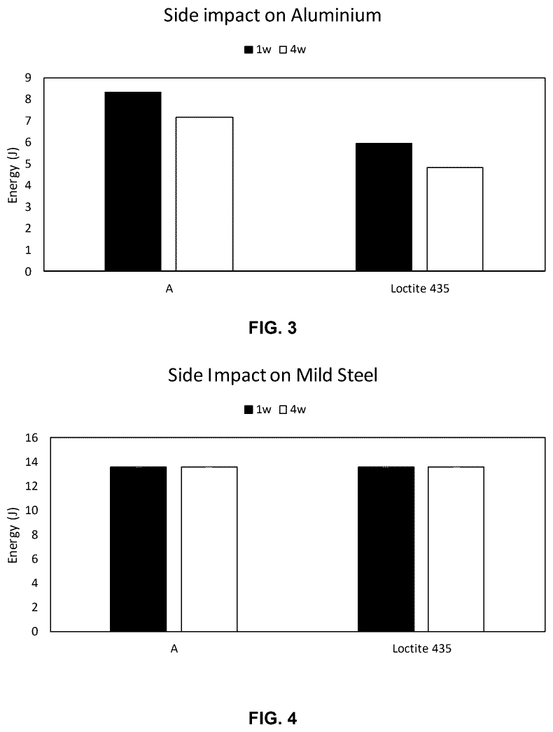

With reference to FIGS. 3 and 4 and the data captured in Table 6, the side impact evaluation shows significant improvement on the aluminum substrates for Sample A over LOCTITE 435. On the mild steel substrates, comparable toughness was observed with Sample A and LOCTITE 435, though in each case improved over that shown on aluminum substrates.

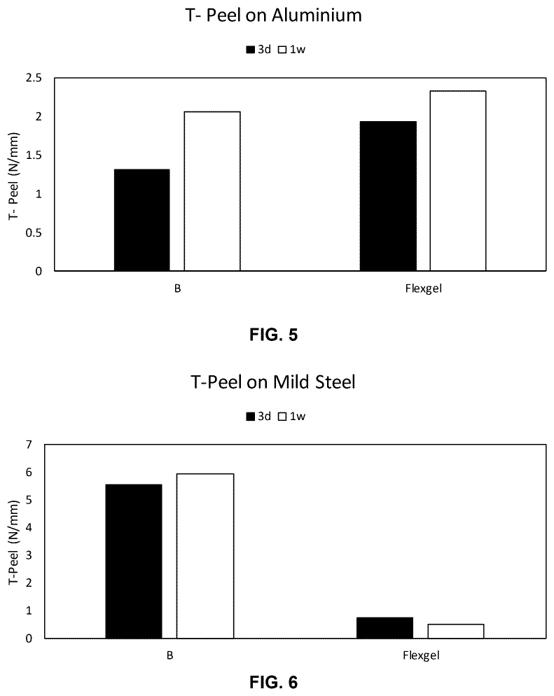

FIGS. 5 and 6 show the T-Peel strength performance of Sample B compared with LOCTITE FlexGel as evaluated on aluminum and mild steel substrates after 3 days and 1 week of aging. On aluminum, the T-Peel strength performance was comparable with that shown by LOCTITE FlexGel.

But on mild steel substrates the surprising result was the T-Peel strength performance—5 N/mm. This performance is impressive for any cyanoacrylate adhesive, and exceptional for a low odor/low bloom cyanoacrylate adhesive that contains β-methoxy ethyl cyanoacrylate.

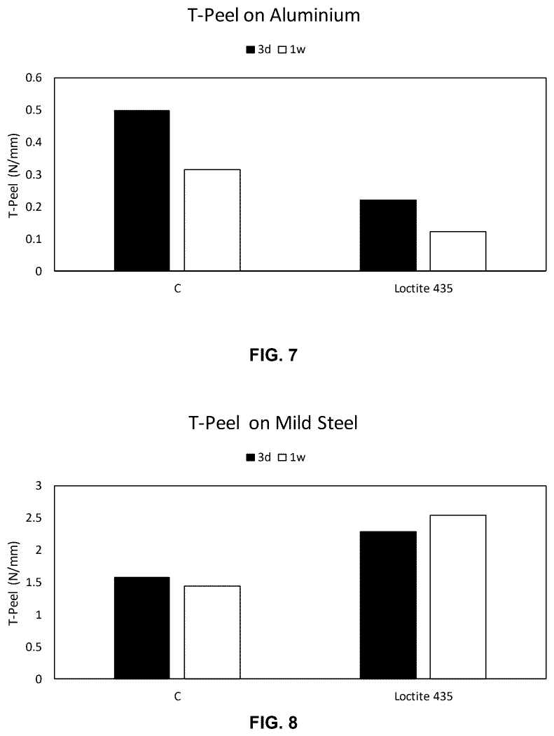

Table 7 shows the T-Peel strength performance for the 2-methyl butyl cyanoacrylate-containing compositions (shown in Table 4). FIGS. 7 and 8 highlights graphically the comparable T Peel strength performance for Sample C and LOCTITE 435 on aluminum substrates.

TABLE 7

| | Sample/T-Peel (N/mm) | | | |
|---|---|---|---|---|
| | | | LOCTITE | LOCTITE |
| Time (weeks)/Substrate | C | D | 435 | FlexGel |
| 3 days/Al | 0.49 | 2.10 | 0.22 | 2.05 |
| 1/Al | 0.32 | 3.62 | 0.12 | 2.20 |
| 3 days/MS | 1.57 | 3.84 | 2.30 | 1.62 |
| 1/MS | 1.44 | 4.78 | 2.55 | 1.54 |

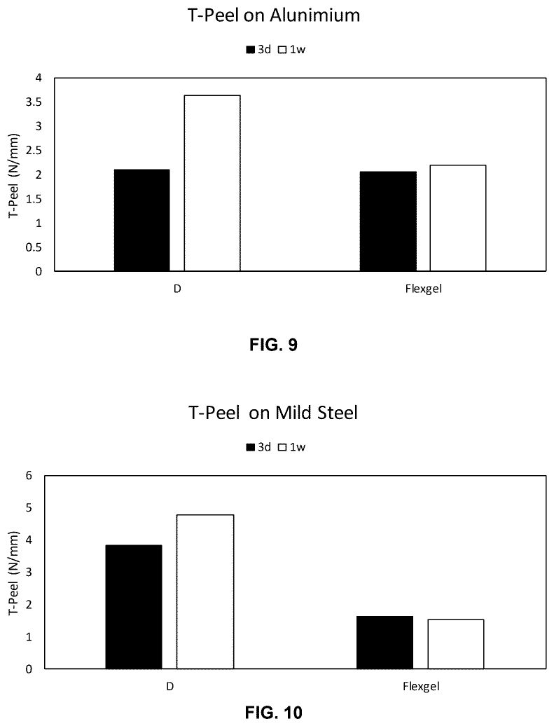

In FIGS. 9 and 10, Sample D was compared with LOCTITE FlexGel as the control and shows T-Peel strength performance on aluminum and mild steel LOCTITE FlexGel. Surprisingly by moving to a gel formulation, an improvement over LOCTITE FlexGel is observed in T-Peel strength performance on both the mild steel and the aluminum substrates.

In Table 8 below, three samples were prepared to evaluate the effect of silica and silica with citric acid. Each sample was stabilized with methane sulfonic acid and sulfur dioxide.

TABLE 8

| | Sample/Amt (wt %) | | |
|---|---|---|---|
| Components | E | F | G |
| Isoamyl cyanoacrylate | 28.05 | 26.25 | 25.80 |
| β-Methoxy cyanoacrylate | 63.95 | 59.75 | 60.19 |
| VCS 5500 | 8 | 8 | 8 |
| MSA | 0.0015 | 0.0015 | 0.0015 |
| SO₂ | 0.002 | 0.002 | 0.002 |
| Silica | — | 6 | 6 |
| Citric Acid | — | — | 0.005 |

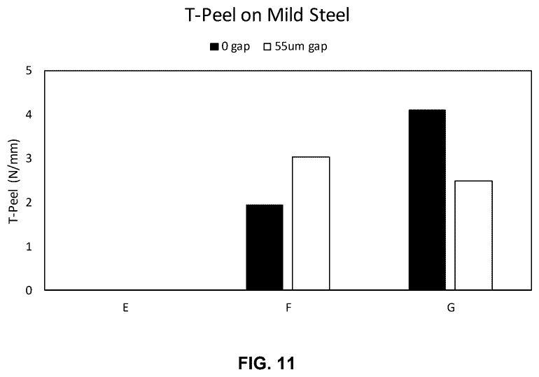

Reference to FIG. 11 shows that T-Peel strength performance on mild steel substrates improved with the addition of silica (Sample F) and then again with the addition of silica and citric acid (Sample G), both with and without a gap of 55 μm between the substrates although the performance with the added silica and citric acid (Sample G) reverses the relative performance of the gapped and ungapped substrates compared with only silica added (Sample F).

1-21. (canceled)

22. A cyanoacrylate composition, comprising:
(a) a β-alkoxyalkyl cyanoacrylate component,
(b) a cyanoacrylate component selected from the group consisting of 2-methylbutyl cyanoacrylate, isoamyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof; and
(c) a rubber toughening component which is dissolved in the composition and selected from the group consisting of (a) reaction products of the combination of ethylene, methyl acrylate and monomers having carboxylic acid cure sites, (b) dipolymers of ethylene and methyl acrylate, (c) vinylidene chloride-acrylonitrile copolymers, (d) vinyl chloride/vinyl acetate copolymer, (e) copolymers of polyethylene and polyvinyl acetate, and combinations thereof,
wherein the β-alkoxyalkyl cyanoacrylate component (a) is present from 55% to 75% by weight and the cyanoacrylate component (b) is present from 20% to 35% by weight based on the total weight of the composition.

23. The composition according to claim 22, wherein the β-alkoxyalkyl cyanoacrylate component is selected from β-methoxy ethyl cyanoacrylate, β-ethoxy ethyl cyanoacrylate, and combinations thereof.

24. The composition according to claim 22, wherein the rubber toughening component is a reaction product of the combination of ethylene, methyl acrylate and monomers having carboxylic acid cure sites, wherein the reaction product is free of release agents, anti-oxidants, stearic acid and polyethylene glycol ether wax.

25. The composition according to claim 22, further comprising one or more of a thixotrope, a gelling agent, a thickener, an accelerator and a shock resistance conferring agent.

26. The composition according to claim 25, wherein the accelerator is selected from the group consisting of calixarene, oxacalixarene, silacrown, cyclodextrin, crown ether, poly(ethyleneglycol) di(meth)acrylate, ethoxylated hydric compound, and combinations thereof.

27. The composition according to claim 26, wherein the calixarene is tetrabutyl tetra[2-ethoxy-2-oxoethoxy]calix-4-arene.

28. The composition according to claim 26, wherein the crown ether is selected from members within the group consisting of 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5,3,4,5-naphtyl-16-crown-5, 1,2-methyl-benzo-18-crown-6, 1,2-methylbenzo-5,6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6, and 1,2-benzo-1,4-benzo-5-oxygen-20-crown-7 and combinations thereof.

29. The composition according to claim 26, wherein the poly(ethyleneglycol) di(meth)acrylate is within the following structure: 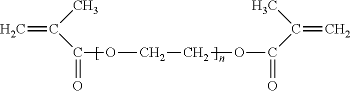
wherein n is greater than 3.

30. The composition according to claim 25, wherein the shock resistance conferring agent is citric acid.

31. The composition according to claim 22, wherein the β-alkoxyalkyl cyanoacrylate component (a) and the cyanoacrylate component (b) are present in the composition in a by weight ratio in the range of 70:30.

32. The composition according to claim 22, further comprising a stabilizing amount of an acidic stabilizer and a free radical inhibitor.

33. The composition according to claim 22, further comprising a cyanoacrylate component within the structure H2C═C(CN)—COOR, wherein R is selected from C1-15 alkyl, alkoxyalkyl, cycloalkyl, alkenyl, aralkyl, aryl, allyl and haloalkyl groups.

34. The composition according to claim 22, wherein the rubber toughening component is present in an amount of from 5% to 15% by weight, based on the total weight of the composition.

35. Reaction products of the composition according to claim 22.

36. A composition comprising:
(a) a cyanoacrylate component selected from the group consisting of 2-methylbutyl cyanoacrylate, isoamyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof, and
(b) a rubber toughening component which is dissolved in the composition and selected from the group consisting of (a) reaction products of the combination of ethylene, methyl acrylate and monomers having carboxylic acid cure sites, (b) dipolymers of ethylene and methyl acrylate, (c) vinylidene chloride-acrylonitrile copolymers, (d) vinyl chloride/vinyl acetate copolymer, (e) copolymers of polyethylene and polyvinyl acetate, and combinations thereof,
wherein the cyanoacrylate component (a) is present from 20% to 35% by weight based on the total weight of the composition.

37. A composition comprising a rubber toughening component which is selected from the group consisting of (a) reaction products of the combination of ethylene, methyl acrylate and monomers having carboxylic acid cure sites, (b) dipolymers of ethylene and methyl acrylate, (c) vinylidene chloride-acrylonitrile copolymers, (d) vinyl chloride/vinyl acetate copolymer, (e) copolymers of polyethylene and polyvinyl acetate, and combinations thereof dissolved in an amount of up to 20 weight percent in a cyanoacrylate component selected from the group consisting of 2-methylbutyl cyanoacrylate, isoamyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof.

38. A method of bonding together two substrates, comprising the steps of: applying a composition according to claim 22, to at least one of the substrates, and mating together the substrates for a time sufficient to permit the composition to fixture.

39. A method of preparing a composition according to claim 22, comprising the steps of:
providing a rubber toughening component dissolved in a cyanoacrylate component selected from the group consisting of 2-methylbutyl cyanoacrylate, isoamyl cyanoacrylate, 2-pentyl cyanoacrylate, 3-methylpentyl cyanoacrylate, 2-ethylbutyl cyanoacrylate, 3,7-dimethyloctyl cyanoacrylate, and combinations thereof, and combining therewith with mixing a β-alkoxyalkyl cyanoacrylate component.
